(19) United States
(12) Patent Application Publication
(10) Pub. No.: US 2010/0218907 A1
(43) Pub. Date: Sep. 2, 2010

(54) Non-Dried Continuous Bulk Packaged Roving For Long Fiber Thermoplastics And A System For Collecting Same

(76) Inventors: Leonard J. Adzima, Pickerington, OH (US); Clark T. Forbes, Newark, OH (US); Michael B. Fazio, Newark, OH (US)

Correspondence Address: OWENS CORNING, 2790 COLUMBUS ROAD, GRANVILLE, OH, 43023, US

(21) Appl. No.: 12/394,854

(22) Filed: Feb. 27, 2009

(51) Int. Cl. D21H 13/40; C03B 37/01

(52) U.S. Cl. 162/3; 162/289

(57) ABSTRACT

The formation and bulk packaging of continuous wet roving is provided. Glass fibers are attenuated from a bushing, gathered into a roving, and collected as a loose, wet mass in a container assembly. A rotating deflector assembly is used to reduce the velocity of the wet roving in-line and to direct the wet continuous roving into the container. The deflector is formed of a plurality of fingers extending radially from a central hub. The curved end of the fingers permits both for the capture and easy release of the roving from the deflector. A stripper assembly may be used to remove the wet continuous roving from the fingers. After being released from the fingers, the wet roving is permitted to fall into the container assembly under the force of gravity. The wet bulk continuous roving can be utilized in various processes that form long fiber thermoplastics and reinforced composite articles.

### TECHNICAL FIELD AND INDUSTRIAL APPLICABILITY OF THE INVENTION

The present invention relates generally to bulk roving, and more particularly, to the formation and packaging of continuous wet bulk roving. A system for collecting continuous bulk roving is also provided.

### BACKGROUND OF THE INVENTION

Glass fibers are useful in a variety of technologies. For example, glass fibers are commonly used as reinforcements in polymer matrices to form glass fiber reinforced plastics or composites. Glass fibers have been used in the form of continuous or chopped filaments, strands, rovings, woven fabrics, nonwoven fabrics, meshes, and scrims to reinforce polymers. Glass fibers are commonly used as reinforcements in polymer matrices to form glass fiber reinforced plastics or composites because they provide dimensional stability as they do not shrink or stretch in response to changing atmospheric conditions. In addition, glass fibers have high tensile strength, heat resistance, moisture resistance, and high thermal conductivity. It is known in the art that glass fiber reinforced polymer composites possess higher mechanical properties compared to unreinforced polymer composites, provided that the reinforcement fiber surface is suitably modified by a sizing composition. Thus, better dimensional stability, tensile strength and modulus, flexural strength and modulus, impact resistance, and creep resistance may be achieved with glass fiber reinforced composites.

Conventionally, glass fibers are formed by attenuating streams of a molten glass material from a bushing or orifice. An aqueous sizing composition, or chemical treatment, commonly containing lubricants, coupling agents, and film-forming binder resins, is applied to the glass fibers after they are drawn from the bushing. The sizing composition provides protection to the fibers from interfilament abrasion and promotes compatibility between the glass fibers and the matrix in which the glass fibers are to be used.

The wet, sized fibers may then be split and gathered into rovings at a gathering shoe and wound onto a collet into forming packages or cakes. The forming cakes are heated in an oven at a temperature from about 212° F. to about 270° F. for 15 to 20 hours to remove water and cure the size composition on the surface of the fibers. In some instances, the dried rovings are transported to a chopper where the fibers are chopped into chopped strand segments. The chopped strand segments may be mixed with a thermoplastic resin and supplied to a compression- or injection-molding machine to be formed into glass fiber reinforced composites. Such a process is referred to as an “off-line” process because the fibers are dried and chopped after the glass fibers are formed. In addition, the process is considered a “two-step” process because the polymeric resin must be separately supplied to the glass fibers to form a glass fiber/resin mixture which is then processed, such as by heat, to melt the resin and disperse the fibers throughout the composite product.

In other instances, the dried glass rovings are unwound from the collet and impregnated with a thermoplastic resin, typically by pulling the roving through a die. These coated rovings may be converted into a charge and compression molded to form a composite article. The coated rovings may also be used to form long fiber thermoplastic (LFTP) pellets. These processes are also off-line, two-step processes in that (1) the glass must be made, gathered into strands, and dried and (2) the strands are off-line impregnated with a thermoplastic resin.

Although the current off-line processes forms suitable and marketable end products, the off-line process is time consuming not only in that the forming and chopping or forming and impregnation occurs in two separate steps, but also in that it requires extensive, lengthy drying times to fully cure the size composition. Thus, there exists a need in the art for a cost-effective and efficient process for manufacturing roving that can be effectively utilized to form molded composite products. There also exists a need in the art for the simplification of the formation of molded composite parts.

### SUMMARY OF THE INVENTION

It is an object of the present invention to provide a method of making a bulk continuous wet roving product. Glass fibers are gathered into a continuous wet roving and directed towards a deflector assembly. The deflector assembly includes a plurality of fingers that extend radially from a central hub. The deflector assembly absorbs the inertial forces of the continuous wet roving prior to its collection into a container assembly. In operation, the continuous wet roving is caught on the fingers as the central hub spins in a clockwise or counterclockwise direction. The outer portions of the fingers have a degree of curvature that permits the continuous wet roving to be captured and then released into the container assembly. A stripper device may be utilized to assist in removing the continuous wet roving from the fingers of the deflector assembly. After being released from the fingers, the continuous wet roving is permitted to fall into the container assembly under the force of gravity. In at least one exemplary embodiment, the deflector assembly or the container assembly may be transversely reciprocated to distribute the continuous wet roving substantially evenly within the container assembly. In addition, the container assembly may be vibrated during the collection process to compact the continuous wet roving and increase the density of the resulting bulk package. Once the container is full or reaches a desired amount, the container assembly is sealed for storage or shipment to customers.

It is also an object of the present invention to provide a deflector assembly for directing continuous wet roving into a container assembly. The deflector assembly is formed of fingers extending radially from a central hub that is mounted for rotation about a generally vertical axis of rotation. Desirably, the fingers are substantially evenly spaced around the circumference of the hub. The fingers each include a shaft portion that terminates at a curved end. The curved end portion deflects horizontally and vertically relative to the shaft portion to facilitate the release of the continuous wet roving into a container assembly. In at least one exemplary embodiment, the curved end portion has a vertical angular deflection relative to the shaft portion of the finger from about 10 degrees to about 45 degrees and a horizontal angular deflection relative to the shaft portion from about 10 degrees to about 30 degrees. The curved end portion is preferably oriented such that the curved end portion trails the direction of rotation of the deflector.

It is a further object of the present invention to provide a system for collecting a continuous bulk wet roving product. The system includes an attenuator to pull the continuous wet roving and direct it towards a rotating deflector assembly, a rotating deflector assembly to absorb the inertial forces of the continuous wet roving, and a container assembly to collect and contain the continuous wet roving. The deflector assembly is formed of fingers positioned on a central hub that is mounted for rotation about a generally vertical axis of rotation. The fingers include a shaft portion that terminates at a curved end portion. The shaft portions extend radially from the central hub and are desirably substantially evenly spaced around the circumference of the central hub. The deflector assembly reduces the velocity of the continuous wet roving and directs the continuous wet roving into the container assembly. A stripper device may be utilized to remove or assist in the removal of the continuous wet roving from the fingers without wrapping or damaging the continuous wet roving. After being released from the fingers, the continuous wet roving is permitted to fall into the container assembly under the force of gravity. In exemplary embodiments, the deflector assembly or the container assembly reciprocates transversely to laterally distribute the wet continuous roving substantially evenly within the container assembly.

It is an advantage of the present invention that the wet continuous bulk roving is less expensive to manufacture than dry roving packages because dry roving packages are typically wound and dried in separate steps.

It is also an advantage of the present invention that the bulk packaging of the continuous wet roving eliminates the need for precision winders in the processing line.

It is a further advantage of the present invention that there is no “sling off” of the size composition and less waste of the size composition.

It is another advantage of the present invention that less splicing required for the bulk continuous wet roving compared to conventional dry roving packages.

It is also an advantage of the present invention that the deflector is formed with projecting fingers having curved ends that permit the easy capture and release of the continuous wet roving.

It is yet another advantage of the present invention that the deflector absorbs the inertial forces of the roving prior to its collection into the container assembly so that the roving can fall into the container by the force of gravity.

It is a feature of the present invention that the container holding the wet continuous bulk roving can be shaped and configured to meet the individual needs of the customers.

It is a further feature of the present invention that the process of the invention allows for bulk packaging of wet roving in quantities larger than is capable for conventional dried, wound roving.

It is also a feature of the present invention that hard migrated turnarounds that are associated with standard dry, single end roving doffs are eliminated.

It is another feature of the present invention that the amount of content the wet roving has with any surface is less than about 5%, which minimizes damage to and/or splitting of the wet roving that may be caused by direct impact of the continuous wet roving to a surface.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a continuous bulk wet roving collection system according to at least one exemplary embodiment of the present invention;

FIG. 2 is a schematic illustration of a portion of the bulk wet roving collection system of FIG. 1 depicting the deflector assembly in cross-section, the loops of wet roving corresponding to the fingers broken away being shown in phantom;

FIG. 3 is a schematic illustration of the top view of a deflector according to at least one exemplary embodiment of the present invention;

FIG. 4 is a cross-sectional view of the deflector taken along lines A-A of FIG. 3 to illustrate the curved fingers of the deflector;

FIG. 5 is a schematic illustration of a processing line for forming chopped strand segments from bulk continuous wet roving;

FIG. 6 is a schematic illustration of an injection molding process using chopped strand segments from continuous bulk wet roving according to at least one exemplary embodiment of the present invention;

FIG. 7 is a schematic illustration of an injection molding process using continuous dried bulk wet roving according to one exemplary embodiment of the present invention;

FIG. 8 is a schematic illustration of an injection molding process using bulk continuous wet roving according to one exemplary embodiment of the present invention; and

FIG. 9 is a schematic illustration of a compression molding process according to one aspect of the present invention for forming a composite molded product.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity. It is to be noted that like numbers found throughout the figures denote like elements. The terms “sizing composition”, “sizing”, and “size” may be used interchangeably herein.

The present invention relates to the formation and bulk packaging of wet continuous roving. In particular, a continuous wet roving is formed as described below and is loosely and randomly packaged in a wet state in a container assembly. A deflector assembly is utilized in-line to direct the wet continuous roving into the container assembly. Because the roving is not dried prior to use, the bulk packaged wet continuous roving has low manufacturing costs, which helps to prevent an increase in overall production costs. The wet bulk continuous roving can be utilized in various processes that form long fiber thermoplastics (LFTP) and reinforced composite articles.

Fibers suitable to form the roving should be thermally stable, and may be any type of glass fiber, such as A-type glass fibers, C-type glass fibers, E-type glass fibers, S-type glass fibers, ECR-type glass fibers (e.g., Advantex® glass fibers commercially available from Owens Corning), wool glass fibers, or combinations thereof. The use of other reinforcing fibers such as natural fibers, mineral fibers, carbon fibers, ceramic fibers, and/or synthetic fibers such as polyester, polyethylene, polyethylene terephthalate, polypropylene, polyamide, aramid, and/or polyaramid fibers are considered to be within the purview of the invention. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include cotton, jute, bamboo, ramie, bagasse, hemp, coir, linen, kenaf, sisal, flax, henequen, and combinations thereof. In preferred embodiments, the fiber is a glass fiber, and more preferably, Advantex® glass fibers. Although a wide variety and combination of fibers are possible, it is preferred that a majority of the fibers forming the roving are glass fibers, and even more preferably, all of the fibers in the roving are glass fibers. In this regard, and for ease of explanation, the roving will be described hereinafter solely with respect to glass fibers.

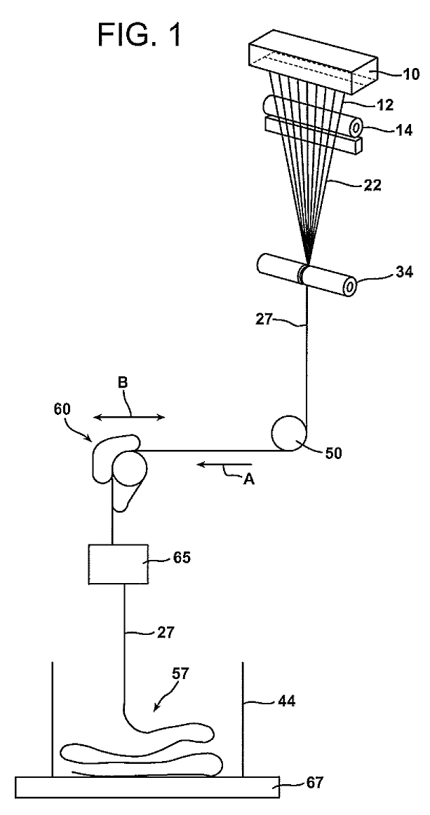

Turning to FIG. 1, glass fibers 12 may be formed by attenuating streams of a molten glass material (not shown) from a bushing 10. The attenuated glass fibers 12 may have diameters from about 8 to about 23 microns, and preferably from about 10 to about 16 microns. After the glass fibers 12 are drawn from the bushing 10, an aqueous sizing composition is applied to the fibers 12. In preferred embodiments, the size composition is compatible with a polypropylene resin. The sizing may be applied by conventional methods such as by the application roller 14 shown in FIG. 1 or by spraying the size directly onto the fibers (not shown) to achieve a desired amount of the sizing composition on the fibers 12. Other application methods such as a kiss roll, dip-draw, or slide are easily identifiable by one of skill in the art. The size is added in amounts suitable to achieve a forming moisture from about 4 to about 14% by weight of the roving, preferably from about 8 to about 10% by weight of the roving, and most preferably about 9% by weight of the roving. The size protects the glass fibers 12 from breakage during subsequent processing, helps to retard interfilament abrasion, and ensures the integrity of the strands of glass fibers, e.g., the interconnection of the glass filaments that form the strand.

The size composition applied to the glass fibers 12 typically includes one or more film forming agents (such as a polyurethane film former, a polyester film former, polypropylene film former, and/or an epoxy resin film former), at least one lubricant, and at least one coupling agent (desirably a silane coupling agent such as an aminosilane coupling agent, methacryloxy silane coupling agent, or glycidyl coupling agent). Film formers create improved adhesion between the glass fibers 12, which result in improved strand integrity. The film former also acts as a polymeric binding agent to provide additional protection to the glass fibers 12 and improves processability of the glass fibers 12, such as a reduction in fuzz generated by high speed chopping. Silane coupling agents enhance the adhesion of the film-forming polymer to the glass fibers and to reduce the level of fuzz, or broken fiber filaments, during subsequent processing. The lubricant facilitates manufacturing and reduces fiber-to-fiber abrasion. When needed, a weak acid such as acetic acid, boric acid, metaboric acid, succinic acid, citric acid, formic acid, and/or polyacrylic acid may be added to the size composition to assist in the hydrolysis of the silane coupling agent.

The size composition further includes water to dissolve or disperse the active solids for application onto the glass fibers. Water may be added in an amount sufficient to dilute the aqueous sizing composition to a viscosity that is suitable for its application to glass fibers and to achieve the desired solids content on the fibers. In particular, the size composition may contain up to about 99% water. The size composition may be applied to the fibers 12 with a Loss on Ignition (LOI) of approximately 0.05-0.75%, and preferably from about 0.05-0.25% on the dried fiber. LOI may be defined as the percentage of organic solid matter deposited on the glass fiber surfaces.

The sized fibers 22 are gathered by the gathering shoe 34 into a roving 27. In some embodiments, the wet continuous roving 27 contains between approximately 50 and 5000 sized fibers 22. Although FIG. 1 depicts the formation of nine fibers 12 for ease of illustration, hundreds or thousands of fibers 12 may be emanated from the bushing 10 and gathered into one or more rovings. It is desirable that the size composition on the fibers 12 forming the roving 27 are compatible with the thermoplastic resin material to facilitate wet-out and provide adequate physical properties to the final composite part.

The wet continuous roving 27 is pulled by an attenuator 60 past guide roller 50 in the direction of arrow “A” and is collected into a storage or collection container 44, The container assembly 44 thus contains loose, wet continuous roving 27, which may be descriptively referred to as “wet rattlesnake” 57. It is to be appreciated that the wet roving 27 in the container has little or no “twist”, unlike conventional dried roving packages. The container assembly 44 may simply be a rigid box with a liquid and air impermeable liner. For example, the container 44 may be formed of plastic, metal, or wood. It is envisioned that the container assembly 44 may be formed in various sizes and shapes, and may be optimized and/or custom made to satisfy plant requirements (e.g., floor space) and specific customer needs. Thus, the container assembly 44 may be formed in various geometric shapes with varying heights, widths, and depths to meet individual customer demands.

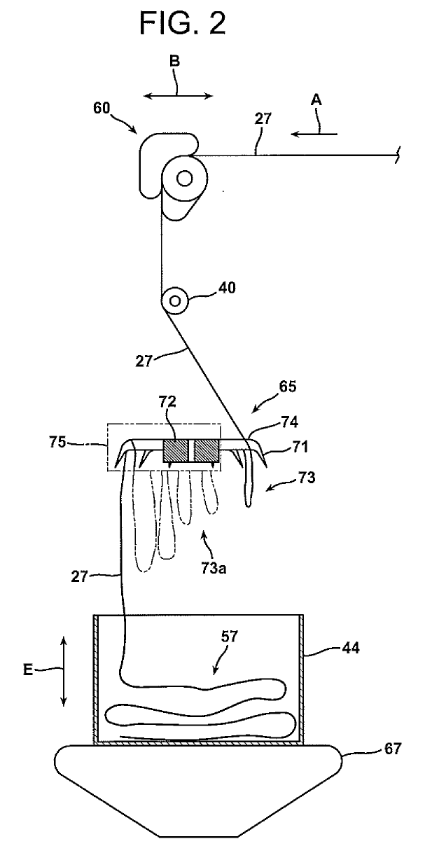

As illustrated in FIG. 2, the wet continuous roving 27 may be directed towards the deflector 65 by guide roller 40. In at least one exemplary embodiment, a deflector assembly 65 or the attenuator 60 and the deflector 65 reciprocate transversely above the container assembly 44 to distribute the continuous wet roving 27 across one dimension of the container 44. Alternatively, the container assembly 44 may reciprocate transversely below the attenuator 60 and deflector 65. In other embodiments, the attenuator 60 and deflector 65 are stationary and the wet roving 27 falls randomly into the container assembly 44 as a loose mass, generally falling as a serpentine pattern of nested loops. One example of a suitable attenuator for use in the instant invention is described in detail in U.S. Patent Publication No. 2004/0016093 to Lueneburger, et al., the content of which is incorporated herein in its entirety.

As shown in FIGS. 1 and 2, the deflector assembly 65 is utilized to direct the wet roving 27 into the container 44. Specifically, the deflector 65 reduces the velocity of the continuous wet roving 27 and directs the wet continuous roving 27 into the container assembly 44, such as in a serpentine fashion. The deflector 65 may be coupled to the attenuator 60, such as by mounting clips, to transverse across the container 44 with the attenuator 60. As the roving 27 is discharged from the attenuator 60, it has a specific linear velocity. If the wet roving 27 has a high velocity, the inertia or momentum of the roving 27 is high which makes bulk collection of the wet roving 27 difficult. When the roving 27 enters the container assembly 44 with a high velocity, the roving may separate or fluff upon impact with the previously deposited layers of roving 27, resulting in damage to the roving 27 or penetration of the previously deposited layers of roving 27. Such penetration makes subsequent removal of the wet continuous roving 27 difficult if not impossible. The deflector 65 absorbs the inertial forces of the roving 27 prior to its collection into the container assembly 44. Additionally, the deflector 65 introduces at least one dimension to the area over which the wet roving 27 is deposited, rather than just a single line. It is to be noted that a low velocity will not create problems with the collection and/or removal of the wet roving 27 from the container assembly 44.

The attenuator 60 and the deflector 65 may move along the longitudinal direction of the container assembly 44 in the direction of arrow “B” as shown in FIGS. 1 and 2 to distribute the roving 27 along the length of the container 44. When the attenuator 60 and the deflector 65 reach one end of the container assembly 44, the deflector 65 turns around and the attenuator 60 and the deflector 65 traverse to the other end. By rotating the deflector 65, the wet roving 27 is distributed laterally in the container assembly 44. This traversing pattern continues until the container assembly 44 is filled or is otherwise manually stopped. In addition, the wet roving 27 is desirably directed by the deflector 65 into the corners of the container 44 to maximize the amount of wet roving 27 that may be placed in the container assembly 44. The wet roving 27 may be deposited in a variety of patterns in the container 44, such as serpentine, arcuate, random, and circular patterns, depending on the movement of the attenuator 60 and deflector 65 and/or the container assembly 44.

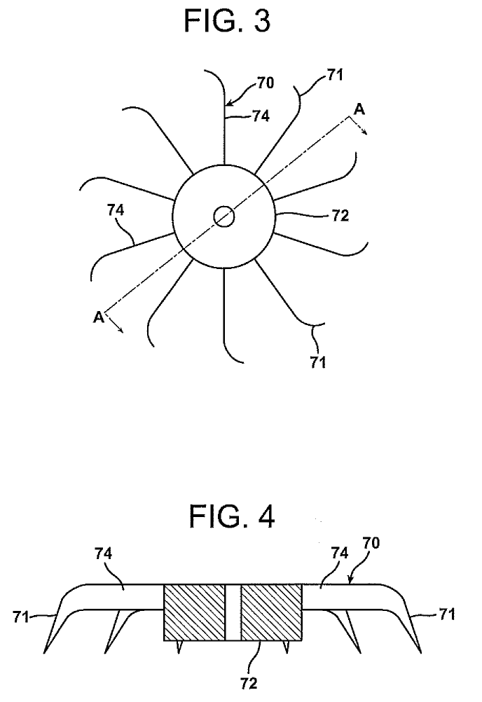

Looking at FIGS. 2-4, it can be seen that the deflector 65 is formed of fingers or wings 70 positioned on a central hub or wheel assembly 72 that is mounted for rotation about a generally vertical axis of rotation. The fingers 70 include a shaft portion 74 that terminates at a curved end portion 71. The shaft portions 74 extend radially from the central hub 72 and are substantially evenly spaced around the circumference of the hub 72. In exemplary embodiments, the fingers 70 may have a length defined as the distance from the central hub 72 to the curved end portion 71 of the fingers 70 of from about 3 inches to about 16 inches.

The fingers 70 may be positioned on the central hub 72 so that the deflector assembly 65 can be formed to spin clockwise or counterclockwise. In FIG. 2, the deflector 65 is positioned to spin clockwise. The deflector 65 is positioned in the forming line such that the wet roving 27 falls or is forced between the fingers 70. In operation, the wet roving 27 is caught on the fingers 70 as the wheel 72 spins in a clockwise (or counterclockwise) direction. The top of the finger 70 desirably contacts about ¼ of an inch of the wet roving 27 per captured loop 73 of wet roving 27. The number, orientation, and/or configuration of the loops 73 of wet roving 27 caught on the fingers 70 are determined by the speed of the roving 27 and the rpm of the wheel 72. Representative loops 73a are depicted in phantom to reflect the loops corresponding to the portion of the deflector 65 that is broken away in the cross-section as the deflector 65 is rotating clockwise.

The contoured shape 71 of the outer portion of the fingers 70, as best seen in FIG. 4, allows for proper capture and release of the wet roving 27. In particular, the outer portion or ends 71 of the fingers 70 have a degree of curvature that permits for both the capture and release of the roving 27. In at least one exemplary embodiment, the curved end portion 71 may have a vertical angular deflection relative to the shaft portion 74 of the fingers 70 from about 10 degrees to about 45 degrees and a horizontal angular deflection relative to the shaft portion 74 from about 10 degrees to about 30 degrees. Additionally, the curved end portion 71 is preferably oriented such that the curved end portion 71 trails the direction of rotation of the deflector 65.

While the hub 72 is spinning, a stripper device 75 may be utilized to remove or assist in the removal of the continuous wet roving 27 from the fingers 72 without wrapping or damaging the roving 27. The stripper device 75 may be any substantially smooth, non-stick solid barrier. The phrase “substantially smooth” is meant to indicate that the stripper device 75 does not contain catch points that might snag the roving 27. The stripping device 75 is desirably cooperable with the fingers 70 to physically remove the wet continuous roving 27 from the curved ends 71 of the fingers 70 as the central hub 72 is rotated about its axis of rotation. For example, the stripper device 75 may be a flexible bar positioned adjacent to the deflector 65 such that the stripper device 75 physically knocks the roving 75 off of the deflector 65. Alternatively, it is envisioned that the stripper device may be an air knife which removes the roving 27 from the deflector 65. After being released from the fingers 70, the continuous wet roving 27 is then permitted to fall into the container assembly 44 under the force of gravity without penetration, or, at most, minimal penetration of the previously deposited layers of wet roving 27 in the container 44. Because of the contoured shape of the outer portions 71 of the fingers 70, the amount of contact the wet roving 27 has with any surface is less than about 5%, thereby minimizing damage to and/or splitting of the wet roving 27 that may be caused by direct impact of the roving 27 to a surface.

The bulk wet roving 27 in the container assembly 44 is loosely and at least substantially evenly distributed within the container 44. The loosely packaged roving 27 within the container assembly 44 is voluminous and has a low density. Accordingly, in some exemplary embodiments, the container assembly 44 may be periodically vibrated by a vibration device 67 in the direction of arrow “E” during the collection process to compact the wet roving 27 and increase the density of the resulting bulk package. The vibration should have an amplitude and frequency sufficient to shift and settle the wet roving 27 in the container assembly 44. The vibration may have multi-directional components, such as vertical (normal to the planes of the parallel layers of collected roving 27), axial (parallel to the longitudinal axis of the container), and/or lateral (perpendicular to the longitudinal axis of the container).

As discussed above, the wet roving 27 is bulk packaged in the container assembly 44. The container assembly 44 should be a container that is sufficiently strong to hold up to about 400 pounds of bulk wet roving 27. Preferably, the container 44 is self-supporting. As one example, a plastic container lined with a liquid and air impermeable liner may be utilized as the container assembly 44. The liner provides a means for bulk removal of the wet roving 27. Other, more complicated container assemblies containing inner and outer containers, such as are described in U.S. Patent Publication No. 2004/0016093 to Lueneburger, et al., are considered to be within the purview of the invention. Once the container 44 is full or reaches a desired amount, the container assembly 44 is sealed for storage or shipment to customers. It is believed that the rigid container will ship better than conventional roving doffs, which are prone to compaction, particularly during shipping.

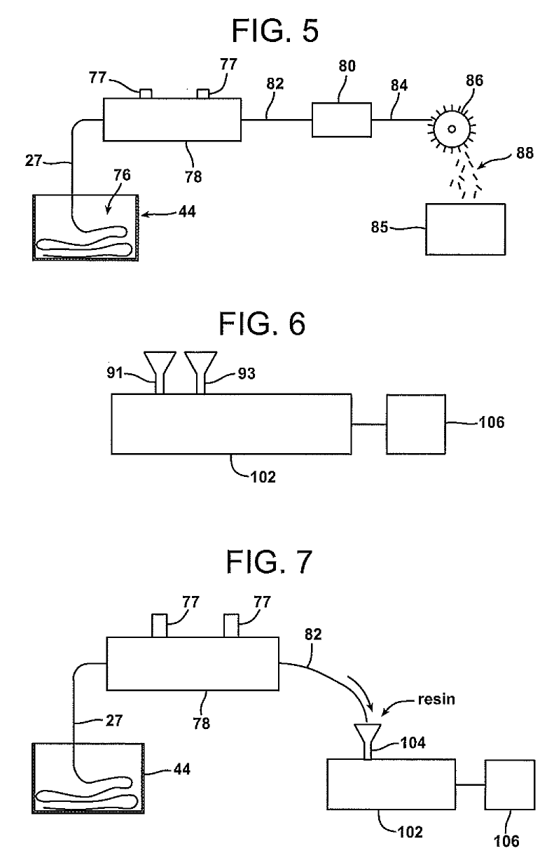

The packaged bulk wet roving 76 can be used, for example, in long fiber thermoplastic applications. For instance, as shown generally in FIG. 5, the wet roving 27 may be removed from the container 44 and passed through a heater 78 or a series of heaters (not illustrated) which dries or substantially dries the roving 27. As used herein, the phrase “substantially dries” is meant to denote that less than about 0.05% of water remains on the roving 27. Water released from the roving 27 in the form of steam may be emitted from vents or openings 77 in the heater 78. The dried, heated roving 82 may then be pulled through a die 80 to impregnate the dried roving 82 with a thermoplastic resin. The impregnated roving 84 may be cut into long fiber strands 88, such as by a chopping apparatus 86, which may then be used in a compression or injection molding process, such as those described below. Because conventional dry roving is heated prior to impregnating the roving with the thermoplastic resin, there are no additional steps required to use the wet bulk roving 27 in long thermoplastic applications. Indeed, the use of the bulk wet roving 27 reduces manufacturing costs and costs to the consumer because the roving 27 is not dried prior to shipment or use, unlike conventional roving packages or doffs. For instance, conventional roving doffs are very time consuming and costly to dry. Further, unlike conventional roving where the packages must be spliced, there is less splicing required for the bulk wet roving 27. Less splicing results in less labor (e.g., no need to change the doffs) and less roving waste.

The chopped strand segments 88 formed from the wet continuous roving 27 may be used in numerous applications, including compression and injection molding processes. For example, the dried chopped fiber strand segments 88 may be supplied to a compression or injection mold to form a glass reinforced composite article. In general, injection molding is a closed molding process where filled or unfilled polymer resins are injected into closed matched metal molds. In at least one embodiment of the invention depicted in FIG. 6, the glass strand segments 88 are supplied to the barrel of an extruder 102 (e.g., a twin screw extruder), such as by a glass feed hopper or port 93. Heat generated by the mechanical action of the screw or screws within the barrel and/or by heaters (not shown) attached to the extruder 102 melts the polymer resin and breaks down the integrity of the strand segments 88. The resultant melted resin/glass fiber mixture may then be injected into a cooled, closed mold 106. After a sufficient period of time in the mold 106, the melted resin/glass fiber mixture cools and forms a solid, reinforced composite article in the shape defined by the mold.

In some exemplary embodiments, an optional thermoplastic polymer resin is added to the barrel of the extruder through a resin feed hopper or port 91 and mixed with the chopped strand glass segments 88 fed into the extruder 102 through port 93 to form the resin/glass fiber mixture. The polymer resin may be in the form of powder, regrind, or polymer pellets. The optional polymer resin or resins may be added to the extruder 102 to adjust the glass content in the final molded part.

Alternatively, the polymer resin and chopped strand segments 88 may be dry mixed and fed together into a single screw extruder where the resin is melted, the integrity of the glass fiber strands is broken down, and the glass fibers are dispersed throughout the molten resin to form the fiber/resin mixture. The fiber/resin mixture may be formed into long fiber thermoplastic pellets. These pellets, in turn, may be fed into a heated mold and formed into molded composite articles that have a substantially homogeneous dispersion of glass fiber strands throughout the composite article.

In a separate embodiment, the wet continuous roving 27 may be used as the input into the extruder. As shown in FIG. 7, the wet roving 27 may be removed from the container assembly 44 in a continuous fashion and passed through one or more ovens 78 to dry the wet roving 27 and form a dried roving 82. The dried roving 82 may then be fed into an extruder 102 through an opening 104 in direct communication with the extruder 102. A thermoplastic resin, typically in the form of pellets, may optionally be added to the extruder 102 such as, for example, to control the glass content in the final molded composite part. In FIG. 7, the optional resin is depicted as entering the extruder 102 though the opening 104 with the wet roving 27. However, the resin may be supplied to the extruder 102 through a separate opening (not illustrated). Similar to the embodiments described above, the integrity of the dried roving 82 is broken down within the extruder 102 (with or without the optional additional polymer) to form a resin/fiber mixture due to the action of the screw and/or the application of heat to the barrel of the extruder 102. In exemplary embodiments, the resin/fiber mixture may be injected directly into a mold 106 to form a composite, reinforced molded part.

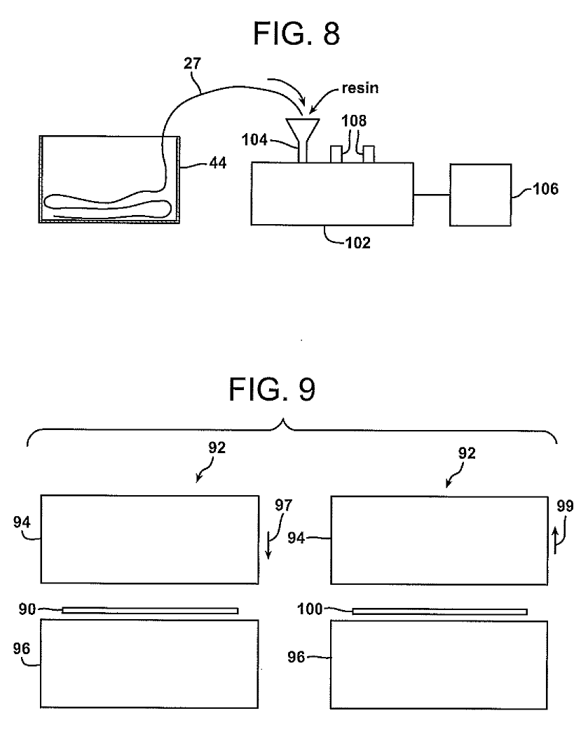

In an alternate embodiment depicted in FIG. 8, the continuous wet roving 27 is fed directly into the extruder 102. In such an embodiment, the extruder 102 contains vents or openings 108 to permit water released from the roving 27 (i.e., steam) to escape the extruder 102. A thermoplastic resin, such as in the form of thermoplastic pellets, is added to the extruder 102 through the opening 104 or by a separate opening (not shown). The integrity of the roving is broken down to form a resin/fiber mixture. The fibers from the roving are mixed with the melted thermoplastic resin to form a resin/fiber mixture, which is injected into a mold 106 to form a reinforced, molded composite part. The resin/fiber mixture may be directly injected into the mold.

In a further alternate embodiment, the chopped strand segments 88 may be used directly in compression molding processes. For instance, a preform (i.e., charge) may be formed from the chopped strand segments 88 and utilized to form a reinforced composite part. Turning to FIG. 9, a preform may be placed into a mold 92 having an upper half 94 and lower half 94. The upper half and lower half 94, 96 of the mold 92 is then closed and heated under a desired pressure to form a composite part 100. In the embodiment depicted in FIG. 9, the upper half 94 of the mold 92 is lowered in the direction of arrow 97 to close the mold 92 around the preform 90. The closed mold 92 is maintained at an elevated temperature for a period of time to cause the matrix resin to melt, flow, and cure. Once the compression molding process is complete, the upper half of the mold 92 moves in the direction of arrow 99 to open the mold 92 and release the composite, molded part 100.

There are numerous advantages provided by the bulk collection of wet continuous roving. As previously discussed, the wet continuous roving 27 is bulk packaged in the container assembly 44 in weights up to about 400 pounds. Thus, the process of the invention allows for bulk packaging of wet roving 27 in quantities larger than is capable for the conventional dried, wound roving (i.e., approximately a 43 pounds per dried, wound package). Additionally, because the roving 27 is not dried prior to shipment or use, the cost of manufacturing the bulk packaged wet continuous roving 27 is significantly reduced. An additional benefit is the increased length provided by the continuous bulk roving compared to conventional roving doffs.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A method of making a bulk continuous wet roving product comprising:
capturing continuous wet roving on a rotating deflector assembly, said deflector assembly including a plurality of fingers extending radially from a central hub;
releasing said continuous wet roving from said deflector assembly; and
permitting said continuous wet roving to fall loosely into a container assembly.

2. The method of claim 1, wherein said releasing step comprises:
removing said continuous wet roving from said deflector assembly via a stripping device.

3. The method of claim 1, further comprising:
forming glass fibers;
applying a size composition to said glass fibers to form sized glass fibers; and
gathering said sized glass fibers into said continuous wet roving.

4. The method of claim 3, wherein said size composition is applied to said glass fibers in an amount suitable to achieve a forming moisture on said continuous wet roving from about 4% to about 14% by weight of the roving.

5. The method of claim 4, wherein said continuous wet roving has less than about 5% contact with said fingers.

6. The method of claim 1, wherein an outer portion of said fingers has a degree of curvature to permit the capture and release of said continuous wet roving.

7. The method of claim 6, further comprising:
recriprocating one of said deflector assembly and said container assembly transversely to distribute said continuous wet roving across at least one dimension of said container assembly.

8. The method of claim 6, further comprising:
vibrating said container assembly to compact said loose continuous wet roving in said container assembly to compact said continuous wet roving and increase the density of said bulk continuous wet roving product.

9. The method of claim 6, wherein said container assembly is a rigid, self-supporting container containing a removable liner impermeable to liquid and air.

10. A deflector assembly for directing continuous wet roving into a container assembly comprising:
a central hub mounted for rotation about an axis of rotation; and
a plurality of fingers spaced around the circumference of said central hub and extending radially therefrom to engage continuous wet roving and direct said continuous wet roving into a container assembly upon rotation of said central hub, each of said fingers being formed with a curved end portion directed downwardly toward said container assembly.

11. The deflector assembly of claim 10, wherein each said finger includes a radially extending shaft portion terminating in said curved end portion, said curved end portion deflecting horizontally and vertically relative to said shaft portion to facilitate the release of said continuous wet roving into said container assembly.

12. The deflector assembly of claim 11, wherein said plurality of fingers are substantially evenly spaced around said central hub.

13. The deflector assembly of claim 12, wherein each of said fingers has a length dimension extending from said central hub to said curved end portion of from about 3 inches to about 16 inches.

14. The deflector assembly of claim 12, wherein each said curved end portion has a vertical angular deflection relative to said radially extending shaft portion in the range from about 10 degrees to about 45 degrees and a horizontal angular deflection relative to said shaft portion in the range from about 10 degrees to about 30 degrees.

15. The deflector assembly of claim 10, further comprising a stripper device cooperable with said plurality of fingers to physically remove said continuous roving from said plurality of fingers as said central hub is rotated about said axis of rotation.

16. A system for collecting a continuous bulk wet roving product comprising:
an attenuator to pull a continuous wet roving;
a rotating deflector assembly cooperable with said continuous wet roving; and
a container assembly to receive said continuous wet roving from said rotating defector assembly,
wherein one of said deflector assembly and said container assembly reciprocate transversely to laterally distribute said continuous wet roving substantially evenly within said container assembly.

17. The system of claim 16, wherein said rotating deflector assembly comprises:
a central hub mounted for rotation about an axis of rotation; and
a plurality of fingers spaced around the circumference of said central hub and extending radially therefrom to engage said continuous wet roving and direct said continuous wet roving into a container assembly upon rotation of said central hub, each of said fingers being formed with a curved end portion directed downwardly toward said container assembly.

18. The system of claim 17, wherein each said finger includes a radially extending shaft portion terminating in said curved end portion, said curved end portion deflecting horizontally and vertically relative to said shaft portion to facilitate the release of said continuous wet roving into said container assembly.

19. The system of claim 17, wherein said plurality of fingers are substantially evenly spaced around said central hub.

20. The system of claim 17, further comprising a stripper device cooperable with said plurality of fingers to physically remove said continuous wet roving from said plurality of fingers as said central hub is rotated about said axis of rotation.
